(19) United States
(12) Patent Application Publication
(10) Pub. No.: US 2023/0334680 A1
(43) Pub. Date: Oct. 19, 2023

(54) AVERAGE DEPTH ESTIMATION WITH RESIDUAL FINE-TUNING

(71) Applicant: Toyota Research Institute, Inc., Los Altos, CA (US)

(72) Inventor: Vitor Guizilini, Santa Clara, CA (US)

(73) Assignee: Toyota Research Institute, Inc., Los Altos, CA (US)

(21) Appl. No.: 17/719,756

(22) Filed: Apr. 13, 2022

(51) Int. Cl. G06T 7/50; G06N 3/08

(52) U.S. Cl. CPC G06T 7/50; G06N 3/08; G06T 2207/20084; G06T 2207/20081

(57) ABSTRACT

A method includes receiving an image of a scene, inputting the image into a trained model, determining an average depth value of the image and pixel-wise residual depth values for the image with respect to the average depth value based on an output of the model, and determining a depth map for the image by adding the average depth value to the pixel-wise residual depth values.

### TECHNICAL FIELD

The present specification relates to creating a depth map for an image and more particularly to average depth estimation with residual fine-tuning.

### BACKGROUND

Depth estimation techniques may be used to obtain a representation of the spatial structure of a scene. In particular, depth estimation techniques may be used to obtain a depth map of a two-dimensional (2D) image of a scene comprising a measure of a distance of each pixel in the image from the camera that captured the image. While humans may be able to look at a 2D image and estimate depth of different features in the image, this can be a difficult task for a machine. However, depth estimation can be an important task for applications that rely on computer vision, such as autonomous vehicles.

In some applications, depth values of an image may be estimated using supervised learning techniques (e.g., using an artificial neural network). However, training a neural network to estimate depth values may take a long time for the network to converge. Accordingly, a need exists for improved depth estimation techniques.

### SUMMARY

In one embodiment, a method may include receiving an image of a scene, inputting the image into a trained model, determining an average depth value of the image and pixel-wise residual depth values for the image with respect to the average depth value based on an output of the model, and determining a depth map for the image by adding the average depth value to the pixel-wise residual depth values.

In another embodiment, a method may include receiving training data comprising a plurality of training images and ground truth depth values associated with each training image, determining an average depth value for each training image based on the ground truth depth values, and training a model to receive an input image and output the average depth value associated with the input image and pixel-wise residual depth values for the input image with respect to the average depth value based on the training data and the determined average depth value for each training image.

In another embodiment, a remote computing device may include a controller programmed to receive an image of a scene, input the image into a trained model, determine an average depth value of the image and pixel-wise residual depth values for the image with respect to the average depth value based on an output of the model, and determine a depth map for the image by adding the average depth value to the pixel-wise residual depth values.

### BRIEF DESCRIPTION OF THE DRAWINGS

The embodiments set forth in the drawings are illustrative and exemplary in nature and are not intended to limit the disclosure. The following detailed description of the illustrative embodiments can be understood when read in conjunction with the following drawings, where like structure is indicated with like reference numerals and in which:

FIG. 1 schematically depicts a system for estimating a depth map for a captured image, according to one or more embodiments shown and described herein;

FIG. 2 depicts a schematic diagram of the server of FIG. 1, according to one or more embodiments shown and described herein;

FIG. 3 illustrates an example neural network architecture for a model that estimates a depth map for a captured image, according to one or more embodiments shown and described herein;

FIG. 4 depicts a flowchart of a method of training the server of FIGS. 1 and 2 to estimate a depth map for a captured image, according to one or more embodiments shown and described herein; and

FIG. 5 depicts a flowchart of a method of operating the server of FIGS. 1 and 2 to estimate a depth map for a captured image, according to one or more embodiments shown and described herein.

### DETAILED DESCRIPTION

The embodiments disclosed herein include methods and systems for estimating depth values of each pixel in a 2D image captured by a camera or other image capture device. That is, for a given image captured by a camera, embodiments disclosed herein may estimate a distance from the camera to each pixel of the image, using the techniques disclosed herein. In particular, a neural network may be trained to estimate an average depth value of an image (e.g., an average value of the depth of each pixel of an image). The neural network may also be trained to estimate pixel-wise residuals for the image with respect to the average depth value. A final depth map for the image may then be determined by adding the average depth value for the image to the pixel-wise residual depth values.

By training the neural network to learn residual depth values of pixels, the quantities learned will be fewer than if the actual depth values are learned, and the average of all the residual depth values will be zero. As such, the neural network will converge more quickly during training, thereby reducing the amount of training time needed.

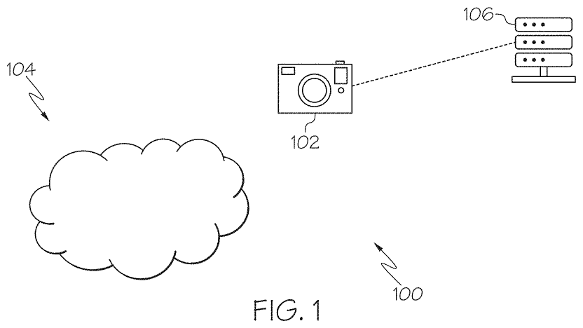

Turning now to the figures, FIG. 1 schematically depicts a system for performing depth estimation for a captured image. In the example of FIG. 1, a system 100 includes a camera 102 that capture an images of a scene 104. A server 106 may be communicatively coupled to the camera 102. In particular, the camera 102 may transmit a captured image to the server 106, which may receive the captured image. The server 106 may then determine an estimated depth map for the image captured by the camera 102, as disclosed in further detail below. In some examples, the server 106 may be a remote computing device located remotely from the camera 102. In some examples, the server 106 may be a cloud computing device. In other examples, the server 106 may be a computing device located near the camera 102.

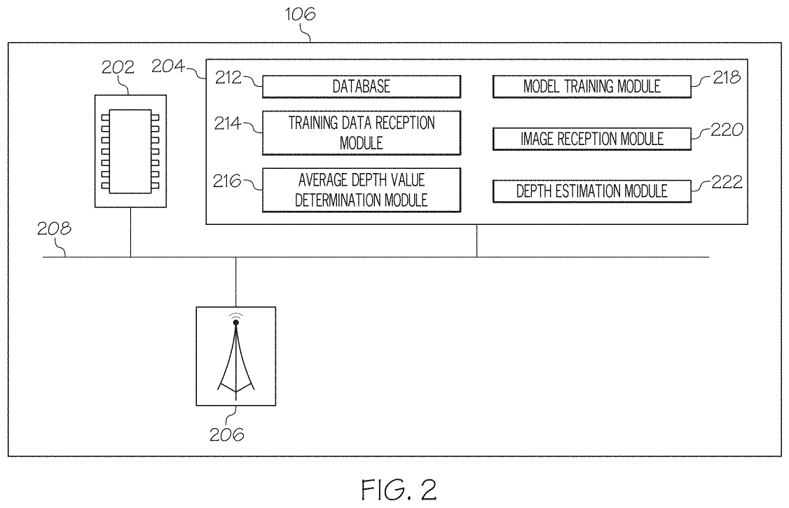

Now referring to FIG. 2, the server 106 comprises one or more processors 202, one or more memory modules 204, network interface hardware 206, and a communication path 208. The one or more processors 202 may be a controller, an integrated circuit, a microchip, a computer, or any other computing device. The one or more memory modules 204 may comprise RAM, ROM, flash memories, hard drives, or any device capable of storing machine readable and executable instructions such that the machine readable and executable instructions can be accessed by the one or more processors 202.

The network interface hardware 206 can be communicatively coupled to the communication path 208 and can be any device capable of transmitting and/or receiving data via a network. Accordingly, the network interface hardware 206 can include a communication transceiver for sending and/or receiving any wired or wireless communication. For example, the network interface hardware 206 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 206 includes hardware configured to operate in accordance with the Bluetooth® wireless communication protocol. The network interface hardware 206 of the server 106 may transmit and receive data to and from one or more cameras (e.g., the camera 102 of FIG. 1) or other devices.

The one or more memory modules 204 include a database 212, a training data reception module 214, an average depth value determination module 216, a model training module 218, an image reception module 220, and a depth estimation module 222. Each of the database 212, the training data reception module 214, the average depth value determination module 216, the model training module 218, the image reception module 220, and the depth estimation module 222 may be a program module in the form of operating systems, application program modules, and other program modules stored in the one or more memory modules 204. In some embodiments, the program module may be stored in a remote storage device that may communicate with the server 106. Such a program module may include, but is not limited to, routines, subroutines, programs, objects, components, data structures and the like for performing specific tasks or executing specific data types as will be described below.

The database 212 may store image data received from the camera 102. The database 212 may also receive training data used to train a model to estimate a depth map for a captured image, as disclosed herein. The database 212 may also store parameters associated with the model. The database 212 may also store other data used by the memory modules 204.

The training data reception module 214 may receive training data used to train the model maintained by the server 106. As discussed above, the server 106 may maintain a model that can receive an image captured by the camera 102 as an input (e.g., an RGB image), and can output a depth map associated with the image. That is, the model may receive an image and may output a depth map estimating a depth of each pixel in the captured image. In the illustrated example, the model comprises a deep neural network. However, in other examples, other types of models may be used.

In order to train the model, training data is acquired by the server 106. In particular, training data comprises a large number of images and an associated depth map for each image. The depth map may act as a ground truth for an image. That is, the depth map associated with an image may represent actual depth values of each pixel of the image. After the training data. reception module 214 receives training data, the model can be trained, as disclosed in further detail below.

The depth map associated with each image of the training data may be determined in a variety of ways. In one example, depth values may be determined using an instrument that measures depth values (e.g, a range finder). In another example, depth values may be determined using self-supervision. For example, multiple images of a scene may be captured by a plurality of cameras from different perspectives. A depth value for an image captured by one of the cameras may then be determined based on the multiple images of the scene captured by the plurality of cameras and known geometry between the cameras.

Whichever technique is used to determine a depth map for an image, the depth map may constitute a ground truth depth map for the image that may be used to train the model maintained by the server 106. The more training data is available, the more accurately the model may be trained. Accordingly, a large amount of training data, comprising a large number of images and associated depth maps, may be used as training data. Furthermore, a variety of different types of images may be used as training data. This may allow the model to be trained to determine depth maps for images more generally, rather than overfitting to a particular type of image.

Referring still to FIG. 2, the average depth value determination module 216 may determine an average depth value for training images received by the training data reception module 214. As discussed above, the training data reception module 214 may receive a plurality of training images and an associated depth map for the image. Thus, the average depth value determination module 216 may determine the average value of the depth across all pixels of a training image (e.g., the mean of the depth values for the pixels of an image). The average depth value may then be used during training of the model, as explained in further detail below. In the illustrated example, the average depth value determination module 216 determines the average depth value for a single image. However, in some examples, the average depth value determination module 216 may determine an average depth value across multiple images of a scene (e.g., the scene 104 of FIG. 1).

Referring still to FIG. 2, the model training module 218 may train the model maintained by the server 106 to estimate a depth map for an input image. The model maintained by the server 106 may receive an RGB image as an input and may output an estimated depth map for the image. The model may comprise a number of parameters stored on the database 212, which may be trained by the model training module 218 using the training data received by the training data reception module 214 and machine learning techniques, as disclosed herein.

In the illustrated example, the model maintained by the server 106 is an artificial neural network, as disclosed herein. However, in other examples, the model may be any other type of model that is able to be trained to receive an input RGB image and output an estimated depth map for the image. In the illustrated example, the model maintained by the server comprises a convolutional neural network with an encoder-decoder architecture. However, in other examples, other types of artificial neural networks may be used.

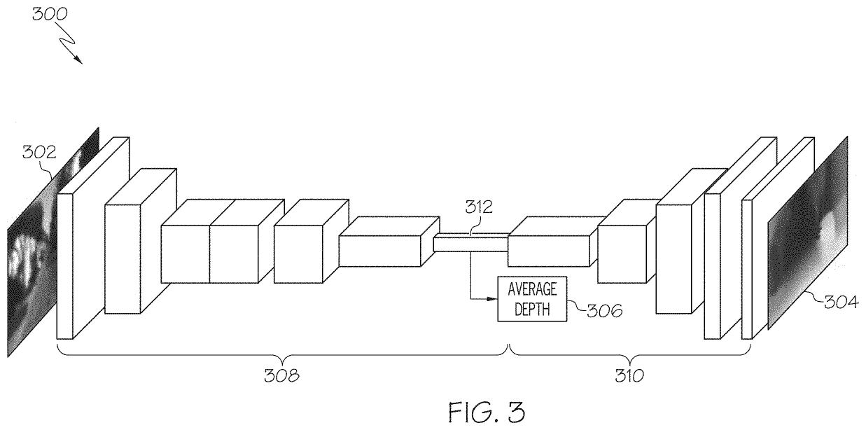

Turning now to FIG. 3, an example architecture of the model maintained by the server 106 is shown. In the example of FIG. 3, the model comprises a neural network 300. The neural network receives a two-dimensional (2D) RGB image 302 as an input and outputs a residual depth map 304 associated with the image. The input image 302 comprises an RUB value for each of a plurality of pixels and the residual depth map 304 comprises a depth value for each pixel of the image 302. In particular, the residual depth map 304 comprises residual depth values for each pixel of the image 302 with respect to the average depth value of the image 302. That is, the residual depth map 304 output by the neural network 300 indicates how much greater than or less than each pixel is than the average depth value.

The neural network 300 also outputs an average depth value 306 of the input image 302. The model training module 218 may train the neural network to output the average depth value 306, as disclosed in further detail below. As such, the average depth value 306 may be added to the pixel-wise residual depth values of the residual depth map 304 to determine an overall depth map that indicates an estimated depth value for each pixel of the image 302.

In the example of FIG. 3. the neural network 300 includes an encoder portion 308 and a decoder portion 310. Each of the encoder portion 308 and the decoder portion 310 comprises a plurality of layers. In the example of FIG. 3, the encoder portion 308 comprises 7 layers and the decoder portion 310 comprises 5 layers. However, it should be understood that in other examples, the encoder portion 308 and the decoder portion 310 may comprise any number of layers. Furthermore, in some examples, the neural network 300 may include one or more skip connections between one or more layers of the neural network 300 and/or other features or neural network architecture portions.

In the example of FIG. 3, the encoder portion 308 of the neural network 300 comprises a plurality of layers, wherein each layer encodes input values from the previous layer into features. Each layer may have any number of nodes, with each node having parameters that may be trained based on training data. Each layer of the encoder portion 308 may comprise a convolutional layer, a pooling layer, a fully connected layer, or other types of layers. As shown in the example of FIG. 3, each layer of the encoder portion 308 either maintains or increases the number of features from the previous layer, while maintaining or reducing the spatial resolution from the previous layer. A central layer 312 of the neural network 300 has the greatest number of features but smallest spatial resolution of all the layers of the neural network 300.

The central layer 312 of the neural network 300 may output a value of the average depth 306 of the input image 302. As discussed above, the training data received by the training data reception module 214 may include a ground truth depth map for each training image, which the average depth value determination module 216 may use to determine an average depth value for each training image. Accordingly, the model training module 218 may train the central layer 312 of the neural network 300 to output an estimated average depth value for the input image 302. For example, the parameters of the layers of the encoder portion 308 of the neural network 300 may be trained in an end-to-end fashion to minimize a loss function based on a difference between the estimated average depth values output by the central layer 312 for all of the training images and the ground truth values of the average depth values determined by the average depth value determination module 216 across all of the training data received by the training data reception module 214. The model training module 218 may train the encoder portion 308 using any optimization method (e.g., gradient descent).

Referring still to FIG. 3. the decoder portion 310 of the neural network 300 may decode the features determined by the encoder portion 308 to determine the residual depth map 304. Similar to the encoder portion 308, each layer of the decoder portion 310 may have any number of nodes, with each node having parameters that may be trained based on training data. Each layer of the decoder portion 310 may comprise a convolutional layer, a pooling layer, a fully connected layer, or other types of layers. As shown in the example of FIG. 3, each layer of the decoder portion 310 either maintains or decreases the number of features from the previous layer, while maintaining or increasing the spatial resolution from the previous layer. As such, the spatial resolution of the residual depth map 304 is the same as the spatial resolution of the input image 302.

The last layer of the decoder portion 310 may output the estimated residual depth map 304 associated with the input image 302, comprising pixel-wise residual depth values for the image 302. Accordingly, the model training module 218 may train the neural network 300 in an end-to-end manner to estimate the residual depth map 304 based on the input image 302. For example, the parameters of the layers of the neural network 300 may be trained to minimize a loss function based on a difference between the values of the estimated residual depth map 304 and the ground truth depth values across all of the training images received by the training data reception module 214. The model training module 218 may train the neural network 300 using any optimization method (e.g., gradient descent).

Accordingly, the model training module 218 may train the neural network 300 to output an estimated residual depth map 304 associated with the input image 302 and an estimated average depth value of the input image 302, based on the training data received by the training data reception module 214. As such, once the neural network 300 is trained, an image with unknown depth values may be input into the trained model (the trained neural network 300) and the model may output an estimated average depth value of the image and an estimated residual depth value for the image. The estimated average depth may then be added to the estimated residual depth value to determine an estimated depth map for the image, as explained in further detail below.

Referring back to FIG. 2, the image reception module 220 may receive an image for which a depth map is to be estimated using the model maintained by the server 106 (e.g., the trained neural network 300). For example, the image reception module 220 may receive an image of the scene 104 captured by the camera 102. After the image reception module 220 receives an image, a depth map of the received image may be estimated by the server 106, as disclosed herein.

Referring still to FIG. 2, the depth estimation module 222 may determine an estimated depth map for the image received by the image reception module 220. In particular, the depth estimation module 222. may utilize the model maintained by the server 106 to determine an estimated depth map associated with the received image. In the illustrated example, the depth estimation module 222. may input the image received by the image reception module 220 into the trained neural network 300 of FIG. 3. The neural network 300 may then output the estimated residual depth map 304 and the estimated average depth 306 associated with the input image. The depth estimation module 222 may then add the estimated average depth 306 to the pixel-wise residual depth values of the estimated residual depth map 304 to determine the estimated depth map of the received image.

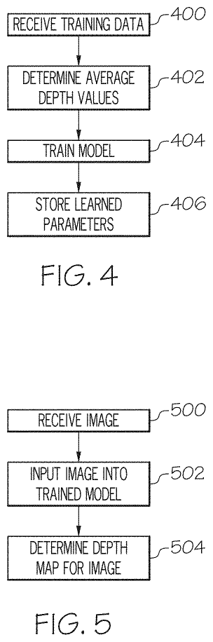

FIG. 4 depicts a flowchart of an example method for training the model maintained by the server 106. In the illustrated example, the model maintained by the server 106 comprises the neural network 300 of FIG. 3. However, in other examples, the model may comprise other neural network architectures or other machine learning models.

At step 400, the training data reception module 214 receives training data. The training data may comprise a plurality of images and ground truth depth maps associated with each image. In particular, each image of the training data may comprise a 2D RGB image. The ground truth depth map associated with each image may comprise a depth value of each pixel of the image.

At step 402, the average depth value determination module 216 determines an average depth value for each image of the received training data. In particular, for each received training image, the average depth value determination module 216 may calculate an average value among the depth values for each pixel of the associated ground truth depth map.

At step 404, the model training module 218 trains the model based on the training data received by the training data reception module 214 and the average depth values determined by the average depth value determination module 216. In particular, the model training module 218 trains the neural network 300 to receive the input image 302, and output the average depth value 306 and the residual depth map 304 comprising pixel-wise residual depth values for the input image 302. For example, the model training module 218 may assign random weights to the nodes of the layers of the encoder portion 308 and the decoder portion 310 of the neural network 300. The model training module 218 may then determine a loss function based on a difference between the average depth value 306 output by the central layer 312 and the average depth values determined by the average depth value determination module 216 for the plurality of training images, and based on a difference between the estimated residual depth map 304 output by the neural network 300 and the ground truth depth maps received by the training data reception module 214 for the plurality of training images. The parameters of the neural network 300 may then be updated using an optimization function (e.g., gradient descent) to minimize the loss function.

At step 406, after the model training module 218 trains the parameters of the neural network 300 to minimize the loss function, the learned parameters may be stored in the database 212.

FIG. 5 depicts a flowchart of an example method for operating the server 106 to determine an estimated depth map for an input image. At step 500, the image reception module 220 receives an input image. For example, the image reception module 220 may receive an RGB image of the scene 104 captured by the camera 102.

At step 502, the depth estimation module 222 inputs the image received by the image reception module 220 into the trained model maintained by the server 106. For example, the depth estimation module 222 may input the image into the trained neural network 300 of FIG. 3. The neural network 300 may then output the estimated average depth value 306 of the image and the estimated residual depth map 304 associated with the image.

At step 504, the depth estimation module 222 determines an estimated depth map associated with the image received by the image reception module 220. In particular, the depth estimation module 222 may add the average depth value 306 output by the neural network 300 to each value of the estimated residual depth map 304 to determine the estimated depth map.

It should now be understood that embodiments described herein are directed to average depth estimation with residual fine-tuning. A model may be trained to receive an image and output an estimated average depth value for the image and an estimated residual depth map for the image comprising pixel-wise residual depth values. The average depth value may be added to the pixel-wise residual depth values to determine an estimated depth map for the image.

The model may comprise a neural network that may be trained by receiving training data comprising a plurality of training images and a ground truth depth map associated with each training image. The neural network may be trained to output an estimated average depth value and an estimated residual depth map based on the training data. Accordingly, because the neural network is trained to output residual depth values, rather than actual depth values, the values output by the neural network may be smaller, and have an average of zero, which may allow the training of the neural network to converge more quickly.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving an image of a scene;
inputting the image into a trained model;
determining an average depth value of the image and pixel-wise residual depth values for the image with respect to the average depth value based on an output of the model; and
determining a depth map for the image by adding the average depth value to the pixel-vise residual depth values.

2. The method of claim 1, wherein the trained model comprises a neural network comprising a plurality of layers.

3. The method of claim 2, wherein the neural network comprises a convolutional neural network.

4. The method of claim 2, wherein the neural network comprises an encoder-decoder architecture comprising an encoder portion and a decoder portion.

5. The method of claim 4, further comprising determining the average depth value of the image based on an output of the encoder portion.

6. The method of claim 4, wherein each layer of the encoder portion outputs a plurality of features based on an output of a previous layer.

7. The method of claim 6, wherein each layer of the encoder portion outputs an equal or greater number of features than the previous layer.

8. The method of claim 6, wherein each layer of the encoder portion has a spatial resolution that is equal to or less than the spatial resolution of the previous layer.

9. The method of claim 1, further comprising training the model to output the average depth value and the pixel-wise residual depth values.

10. The method of claim 9, wherein training the model comprises:
receiving training data comprising a plurality of training images and ground truth depth values associated with each training image;
determining the average depth value for each training image based on the ground truth depth values; and
learning parameters of the model to minimize a loss function based on a difference between the output of the model and the average depth value and the ground truth depth values.

11. A method comprising:
receiving training data comprising a plurality of training images and ground truth depth values associated with each training image;
determining an average depth value for each training image based on the ground truth depth values; and
training a model to receive an input image and output the average depth value associated with the input image and pixel-wise residual depth values for the input image with respect to the average depth value based on the training data and the determined average depth value for each training image.

12. The method of claim 11, wherein the model comprises a convolutional neural network with an encoder-decoder architecture comprising an encoder portion and a decoder portion.

13. The method of claim 12, further comprising training the encoder portion to output the average depth value.

14. A remote computing device comprising a controller programmed to:
receive an image of a scene;
input the image into a trained model;
determine an average depth value of the image and pixel-wise residual depth values for the image with respect to the average depth value based on an output of the model; and
determine a depth map for the image by adding the average depth value to the pixel-wise residual depth values.

15. The remote computing device of claim 14, wherein the trained model comprises a convolutional neural network with an encoder-decoder architecture comprising an encoder portion and a decoder portion, the encoder portion and the decoder portion each comprising a plurality of layers.

16. The remote computing device of claim 15, wherein the controller determines the average depth value of the image based on an output of the encoder portion.

17. The remote computing device of claim 15, wherein each layer of the encoder portion outputs a plurality of features based on an output of a previous layer.

18. The remote computing device of claim 17, wherein each layer of the encoder portion outputs an equal or greater number of features than the previous layer.

19. The remote computing device of claim 17, wherein each layer of the encoder portion has a spatial resolution that is equal to or less than the spatial resolution of the previous layer.

20. The remote computing device of claim 14, wherein the controller is programmed to train the model to output the average depth value and the pixel-wise residual depth values by:
receiving training data comprising a plurality of training images and ground truth depth values associated with each training image;
determining the average depth value for each training image based on the ground truth depth values; and
learning parameters of the model to minimize a loss function based on a difference between the outputs of the model and the average depth value and the ground truth depth values.
